(19) United States
(12) Patent Application Publication
(10) Pub. No.: US 2025/0286185 A1
(43) Pub. Date: Sep. 11, 2025

(54) BATTERY SYSTEM AND METHOD OF ASSEMBLY AND METHOD OF DISASSEMBLY THE BATTERY SYSTEM

(71) Applicant: SAMSUNG SDI CO., LTD., Yongin-si (KR)

(72) Inventors: Simon STACHERL, Sierning (AT); Fritz HARING, Bruck an der Mur (AT)

(21) Appl. No.: 18/967,147

(22) Filed: Dec. 3, 2024

(30) Foreign Application Priority Data
Mar. 7, 2024 (EP) 24162172.1

(51) Int. Cl. H01M 50/209; H01M 50/244; H01M 50/249

(52) U.S. Cl. CPC H01M 50/209; H01M 50/244; H01M 50/249; H01M 2220/20

(57) ABSTRACT

A battery system may include a first battery module and a second battery module in a housing. The first and second battery modules may each include a plurality of battery cells, the first battery module including a first spanner plate the second battery module includes a second spanner plate on at least one of side portions of the battery modules. The first spanner plate and the second spanner plate define an interface therebetween and each may include at least one depression facing each other to form at least one common accommodation space, which may includes a rotation spanner member extending vertically in the respective common accommodation space.

### CROSS-REFERENCE TO RELATED APPLICATION

The present application claims priority to and the benefit of European Patent Application No. 24162172.1, filed on Mar. 7, 2024, in the European Patent Office, the entire disclosure of which is incorporated herein by reference.

### BACKGROUND

### 1. Field of the Disclosure

Aspects of embodiments of the present disclosure relate to a battery system and a method of assembling and disassembling the battery system.

### 2. Description of the Related Art

Recently, vehicles for transportation of goods and peoples have been developed that utilize electric power as a source for motion. Such an electric vehicle is an automobile that is propelled by an electric motor, utilizing energy stored in rechargeable (or secondary) batteries. An electric vehicle may be solely powered by batteries or may be a form of hybrid vehicle powered by for example a gasoline generator or a hydrogen fuel power cell. Furthermore, the vehicle may include a combination of an electric motor and conventional combustion engine. Generally, an electric-vehicle battery (EVB) or a traction battery is a battery used to power the propulsion of battery electric vehicles (BEVs). Electric-vehicle batteries differ from starting, lighting, and ignition batteries because they are designed to provide power for sustained periods of time. A rechargeable (or secondary) battery differs from a primary battery in that it is designed to be repeatedly charged and discharged, while the primary battery is designed to provide an irreversible conversion of chemical to electrical energy. Low-capacity rechargeable batteries are utilized as power supplies for small electronic devices, such as cellular phones, notebook computers and camcorders, while high-capacity rechargeable batteries are utilized as power supplies for electric and hybrid vehicles and/or the like.

Rechargeable batteries may be utilized as battery modules formed of a plurality of unit battery cells electrically connected together in series and/or in parallel to provide high density power, such as for motor driving of a hybrid vehicle. For example, the battery module may be formed by interconnecting the electrode terminals of the plurality of unit battery cells in one or more arrangements or configurations depending on a desired amount of power and to realize a high-power rechargeable battery.

Battery modules can be constructed either in a block design or a modular design. In the block design, each battery is coupled to a common current collector structure and a common battery management system, and the unit thereof is arranged in a housing. In the modular design, pluralities of battery cells are connected to form submodules and several submodules are connected to form the battery module. In automotive applications, battery systems often consist of a plurality of battery modules connected to each other in series to provide a desired voltage. The battery modules may include submodules with a plurality of stacked battery cells and each stack includes cells connected in parallel that are, in turn connected in series (XpYs) or cells connected in series that are, in turn connected in parallel (XsYp).

A battery pack is a set of any number of (often identical) battery modules. The battery modules may be configured in a series, parallel or a mixture of both to deliver the desired voltage, capacity, or power density. Battery packs include the individual battery modules and the interconnects, which provide electrical conductivity between them.

The mechanical integration of such a battery pack incorporates suitable mechanical connections between the individual components, for example, the battery modules, and between the battery modules and a supporting structure of the vehicle. These connections are designed to remain functional and saved throughout the average service life of the battery system. Further, installation space and interchangeability standards should be met, especially in mobile applications.

Mechanical integration of battery modules may be achieved by providing a carrier framework and by positioning the battery modules thereon. Fixing (or securing) the battery cells or battery modules may be achieved by forming fitted depressions in the framework or by mechanical interconnectors, such as bolts or screws. In some cases, the battery modules are confined by fastening side plates to lateral sides of the carrier framework. Moreover, cover plates may be fixed atop and below the battery modules.

The carrier framework of the battery pack may be mounted to a carrying structure of the vehicle. When the battery pack is fixed at the bottom of the vehicle, a mechanical connection may be established from the bottom side by, for example, bolts passing through the carrier framework of the battery pack. The framework may generally made of aluminum or an aluminum alloy to lower the total weight of the construction.

Battery systems according to the prior art, despite any modular structure, often include a battery housing that serves as an enclosure to seal the battery system against the environment and provides structural protection for the battery system's components. Housed battery systems are often mounted as a whole unit into or onto their application environment, for example, an electric vehicle. Thus, replacement of defective system parts, e.g. a defect battery submodule, requires dismounting the entire or substantially the entire battery system and removal of its housing. Even defects of small and/or relatively inexpensive system parts may result in dismounting and replacing the complete battery system and then performing repairs separately. As high-capacity battery systems are relatively expensive, large, and heavy, said procedures may prove to be burdensome and the storage, e.g. in the mechanic's workshop, of the bulky battery systems becomes difficult.

Exothermic decomposition of cell components may lead to a thermal runaway. In general, thermal runaway describes a process that may be accelerated by increased temperature, which in turn releases energy that further increases temperature. Thermal runaway occurs in situations where an increase in temperature changes the conditions in a way that causes a further increase in temperature, often leading to a destructive result. In rechargeable battery systems, thermal runaway is associated with strongly exothermic reactions that are accelerated by temperature rise. These exothermic reactions include combustion of flammable gas compositions within the battery pack housing. For example, if (e.g., when) a cell is heated above a critical temperature (often above 150° C.) it can transit into a thermal runaway. The initial heating may be caused by a local failure, such as an internal short circuit of a cell, heating from a defective electrical contact, and/or short circuit of a neighboring cell. During the thermal runaway, a failed battery cell, e.g., a battery cell which has a local failure, may reach a temperature exceeding 700° C. Further, large quantities of hot gas are ejected from inside of a failed battery cell through vent opening of the cell housing into the battery pack. The main components of the vented gas are H₂, CO₂, CO, electrolyte vapor and other hydrocarbons. The vented gas is therefore burnable and potentially toxic. The vented gas also causes a gas-pressure increase inside the battery system.

At the contact surface between a battery module including a cell stack and a housing in which the battery module is inserted, a machining process is performed to ensure compensation of tolerances. Additionally, a press-fit with the housing is often utilized to provide contact over substantially the whole surface to have substantially homogenous contact area during cell swelling.

Further, to prevent or reduce thermal runaway, a spacer can be provided which separates the cell stack into two groups to avoid setting the second group on fire. However, the present solutions require or desire relatively expensive machining costs and complicated press during assembling. In one or more embodiments, the spacer according to the prior art results in loss of space.

The prior arts aim to improve independently from one another, press-fitting for mechanical stability and spacing for providing a thermal barrier.

### SUMMARY

The present disclosure is defined by the appended claims. The description that follows is subjected to this limitation. Any disclosure lying outside the scope of said claims is only intended for illustrative as well as comparative purposes.

According to one or more embodiments of the present disclosure, a battery system may include: a first battery module and a second battery module in a housing, wherein the first battery module and the second battery module each include a plurality of battery cells, the first battery module including a first spanner plate the second battery module includes a second spanner plate on at least one among a plurality of side portions of the battery modules, wherein the first spanner plate and the second spanner plate define an interface therebetween; the first spanner plate and the second spanner plate each include at least one depression facing each other to form at least one common accommodation space; the at least one common accommodation space includes a rotation spanner member extending vertically in the respective common accommodation space, wherein a cross section of the rotation spanner member includes an elongation in an elongation direction; and the rotation spanner member is oriented such that the elongation direction of the cross section is perpendicular to the interface.

The cross section may include curved portions between two elongation end portions.

The rotation spanner member may be configured to exert an elastic pressing force to the first and second battery module to press-fit the first and second battery module in the housing.

The elongation end portions may be flat and extend perpendicular to the elongation direction.

The at least one depression may be between two protruding portions of the respective spanner plate, wherein the at least one depression includes a flat portion between the two protruding portions.

The flat portion of the at least one depression may abut the flat elongation end portion of the rotation spanner member.

The at least one depression may be between flat plate portions of the respective spanner plate, wherein a depression gap is defined between the at least one depression and a plane defined by the flat plate portions of the respective spanner plate.

The first battery module and the second battery module may include a plurality of frame portions, wherein the respective spanner plate forms at least one of the plurality of frame portions.

At least one of the plurality of frame portions may include a slit configured to couple a flap of the respective spanner plate to the frame portion.

The first spanner plate and the second spanner plate may respectively include two vertically extending depressions, the two vertically extending depressions defining two common accommodation spaces spaced from each other along the interface; and a first and a second rotation spanner members respectively in a corresponding common accommodation space.

According to one or more embodiments of the present disclosure, a method for assembling a battery system may include: inserting a first battery module and a second battery module in a housing, wherein the first battery module and the second battery module each include a plurality of battery cells, wherein the first battery module includes a first spanner plate and the second battery module includes a second spanner plate on at least one among a plurality of side portions of the battery modules, wherein the first battery module and the second battery module are arranged such that the first spanner plate and the second spanner plate define an interface therebetween, and wherein the first spanner plate and the second spanner plate are formed to respectively include at least one vertically extending depression facing each other to form at least one common accommodation space; providing a rotation spanner member in the respective common accommodation space, wherein a cross section of the rotation spanner member includes an elongation in an elongation direction, such that the elongation direction of the cross section is parallel to the interface between the first and second battery module; and rotating at least one rotation spanner member into a state where the elongation direction of the cross section is perpendicular to the interface to exert an elastic pressing force onto the first and second battery module to press-fit the first and second battery module in the housing.

The first spanner plate and the second spanner plate may each respectively include two vertically extending depressions, wherein the two vertically extending depression form two common accommodation spaces spaced from each other along the interface; and wherein a first and a second rotation spanner members are respectively in a corresponding common accommodation space, wherein the rotating the at least one rotation spanner member includes rotating the first and second rotation spanner members in opposite directions.

According to one or more embodiments of the present disclosure, a method for disassembling a battery system may include: rotating at least one of a first or a second rotation spanner member such that the elongation direction is parallel to the interface; removing the at least one of the first or the second rotation spanner members from the respective common accommodation space; and removing at least one among the first battery module and the second battery module from the housing.

The rotating may include rotating the first and second rotation spanner members in opposite directions.

According to one or more embodiments of the present disclosure, a vehicle may include the battery system described according to one or more embodiments of the present disclosure.

### BRIEF DESCRIPTION OF THE DRAWINGS

Features will become apparent to those of ordinary skill in the art by describing in more detail example embodiments with reference to the attached drawings in which:

FIG. 1 is a schematic of a perspective view of a battery system, according to one or more embodiments.

FIG. 2 is an enlarged view of II shown in FIG. 1, according to one or more embodiments.

FIG. 3 is a flow chart of a method of assembling the battery system according to one or more embodiments.

FIG. 4 is a schematic illustrating the method shown in FIG. 3, according to one or more embodiments.

FIG. 5 is a schematic illustrating the method shown in FIG. 3, according to one or more embodiments.

FIG. 6 is a flow chart of a method of disassembling the battery system according to one or more embodiments.

FIG. 7 is a schematic illustrating the method shown in FIG. 6, according to one or more embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

According to one or more embodiments of the present disclosure, a battery system includes a first battery module and a second battery module inserted in a housing. The first battery module and the second battery module may each include a plurality of battery cells. The first battery module may include a first spanner plate, and the second battery module may include a second spanner plate on at least one out of a plurality of side portions of the respective battery module. The first spanner plate and the second spanner plate may be positioned such that they are facing each other. The first spanner plate and the second spanner plate may be formed to respectively include at least one vertically extending depression, which face each other to form at least one common accommodation space. In the at least one accommodation space, a rotation spanner member may be positioned, which is formed to vertically extend in the respective accommodation space, wherein a cross section of the rotation spanner member has an elongation in an elongation direction. The rotation spanner member is oriented such that the elongation direction of the cross section is normal (e.g., perpendicular) to the interface and configured to exert an elastic pressing force onto the first and second battery module to press-fit the first and second battery module in the housing.

Here in the present disclosure, providing a press-fit between the battery modules and the housing means pressing the battery modules against the housing. The term “elongated” means eccentric, e.g., one direction is longer than any other direction. The rotation spanner member may be a hollow body or may be a solid body. The interface means an interface area or an interface plane between the spanner plates. The “rotation spanner” may also be referred to as a “roll spanner member.” The rotation spanner indicates that the rotation spanner can be rotated in the accommodation space. The terms “vertically extending depression” means that the depression extends in a height direction of the battery module.

In some embodiments, the battery system may have a spanning mechanism that provides spacing in the battery system. For example, due to the spanner plates forming (or providing) an interface between the battery modules, the present battery system includes a thermal barrier between the battery cells of the first and the second battery module. In some embodiments, the battery system may achieve a press-fit in the housing by action of the rotation spanner member including a tolerance compensation. Thus, the spacing that is provided by the spanning plates does not result in a loss of space, but rather serves as spanning mechanism to provide the press-fit in the housing. Furthermore, expensive machining costs may be saved. In one or more embodiments, due to the press-fit, tolerances of the battery cells and the housing may be compensated by the press-fit. In one or more embodiments, the battery system can be easily assembled and disassembled by merely rotating the rotation spanner member. Thus, a complicated pressing action can be avoided and in cases where a battery cell is damaged, the battery module may be easily replaced while the rest of the battery system remains usable. Thus, reusability of the battery system is improved.

According to one or more embodiments, a cross section is formed that includes curved portions between two elongation end portions. This may ease a rotation motion of the rotation spanner member. Thus, the assembly and disassembly processes are eased by providing curved portions of the rotation spanner member.

According to one or more embodiments, the cross section is symmetric with respect to the elongation direction. Accordingly, the assembly and disassembly process can be performed by a rotation in both or either directions. Therefore, in the case that two rotation spanner members are provided, they can be symmetrically rotated mirror-inverted to avoid or reduce shear movement of the battery modules in the assembly or disassembly process. Here in the present disclosure, “rotated mirror-inverted” means that the two rotation spanners may be rotated in opposite directions, for example, one may be rotated in a clockwise direction while the other one may be rotated in a counter clockwise direction, thus being a mirror rotation of each other. Therefore, the positioning process of the battery modules in the housing may be improved.

According to one or more embodiments, the elongation end portions may be flat and extend in a direction normal (e.g., perpendicular) to the elongation direction. The flat portions have an effect where the rotation spanner members may not easily rotate back unless intentionally rotated. Therefore, improved stability of the assembled state of the battery system is provided. In other words, the press-fitted configuration is stabilized due to the flatness property of the cross section of the rotation spanner member.

According to one or more embodiments, at least one depression may be formed between two protruding portions of the first and second spanner plates, wherein the depression includes a flat portion between the protruding portions. Thus, a homogeneous press contact with the depression can be provided.

According to one or more embodiments, the flat portion of the depression may abut the flat elongation end portion of the rotation spanner member. Thus, a homogeneous press contact area may be provided, which results in an improved contact for the press-fit and enhances stability of the press-fitted configuration of the battery system. The terms “abut” means directly contacting or pressing against.

According to one or more embodiments, at least one depression may be formed between flat plate portions of the respective spanner plate, wherein a depression gap is provided between the at least one depression and a plane defined by the flat plate portions of the respective spanner plate. Thus, in this case, local thermal conduction across the rotation spanner member and the depression may be reduced significantly. Therefore, despite providing the spanning mechanism between the battery modules, heat transfer may be reduced by the depression gap configuration.

According to one or more embodiments, the first battery module and the second battery module may include a plurality of frame portions, wherein the respective spanner plate forms at least one of the plurality of frame portions. Thus, the spanner plate has an additional function of supporting the battery cells beyond providing the spanning force for the battery modules in the housing and the thermal barrier between the battery cells.

According to one or more embodiments, at least one frame out of a plurality of frame portions may include a slit in which a flap of the spanner plate may be inserted to couple the spanner plate with the corresponding frame portion. This provides a structure to easily mechanically couple the spanner plate with the frame portions. Therefore, the spanner plate provides an end portion of the battery module having both the role of press-fitting the battery modules in the housing as well as providing stability of the battery cells in the battery module itself.

According to one or more embodiments, the first spanner plate and the second spanner plate are formed to respectively include two vertically extending depressions that form two common accommodation spaces spaced apart from each other along the interface. First and second rotation spanner members may be respectively positioned in a corresponding accommodation space. This configuration allows for an additional effect that is more than the sum of the individual effects. In these embodiments, the assembly (and disassembly) process may be improved because by rotating the rotation spanner members in opposite direction, e.g., mirror inverted, a shear movement of the battery modules may be reduced or eliminated. Thus, not only is the assembly process is enhanced, but also the press-fit in the housing may be improved if (e.g., when) two rotation spanner members are provided.

According to one or more embodiments of the present disclosure, a method of assembling a battery system may include inserting a first battery module and a second battery module into a housing, wherein the first battery module and the second battery module each include a plurality of battery cells. The first battery module may include a first spanner plate and the second battery module may include a second spanner plate on at least one out of a plurality of side portions of the battery modules, wherein the first battery module and the second battery module are arranged so that the first spanner plate and the second spanner plate face each other. The first spanner plate and the second spanner plate may be formed to respectively include at least one vertically extending depression facing each other to form at least one common accommodation space. The method may include inserting a rotation spanner member in the respective accommodation space, wherein a cross section of the rotation spanner member has an elongation in an elongation direction, such that the elongation direction of the cross section is normal (e.g., perpendicular) to an interface between the first and second battery module. The method may further include rotating at least one rotation spanner member into a state where the elongation direction of the cross section is normal (e.g., perpendicular) to the interface to exert an elastic pressing force onto the first and second battery module to press-fit the first and second battery module in the housing. The same effects as mentioned above apply here, and also apply to the assembly method.

According to one or more embodiments, the first spanner plate and the second spanner plate are formed to respectively include two vertically extending depressions that form two common accommodation spaces that are spaced from each other along the interface. A first and a second rotation spanner members may be respectively positioned in a corresponding accommodation space. The rotating step may include rotating the first and second rotation spanner members in opposite directions until the elongation direction of the cross section is normal (e.g., perpendicular) to the interface. In these embodiments, the assembly process may be improved because by rotating the rotation spanner members in opposite directions, e.g., mirror inverted, a shear movement of the battery modules may be reduced or eliminated.

Yet in other embodiments of the present disclosure, a method of disassembling the battery system may include providing a battery system as defined according to the one or more embodiments as described above. The method may further include rotating the at least one rotation spanner member so that the elongation direction is parallel to the interface. The method may include removing at least one from among the first battery module and the second battery module from the housing. Thus, the method allows for a relatively easy exchange of defective battery modules or battery cells.

According to other embodiments the rotating may include rotating the first and second rotation spanner member in opposite directions. In these embodiments, the disassembly process can be improved because by rotating the rotation spanner members in opposite directions, e.g., mirror inverted, a shear movement of the battery modules can be reduced.

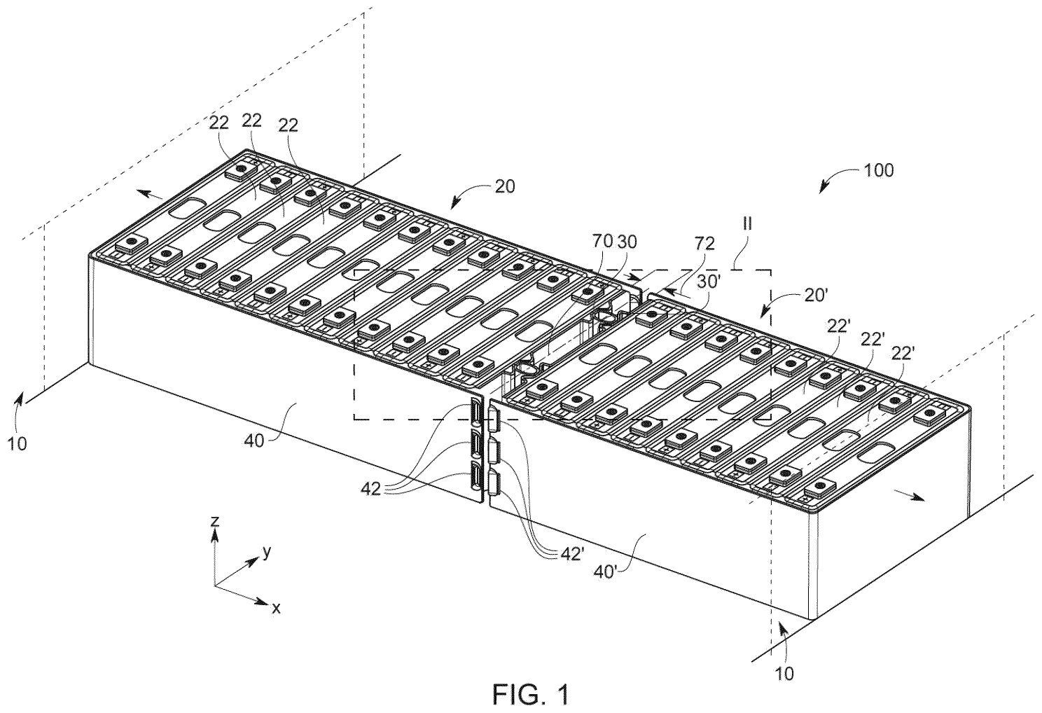

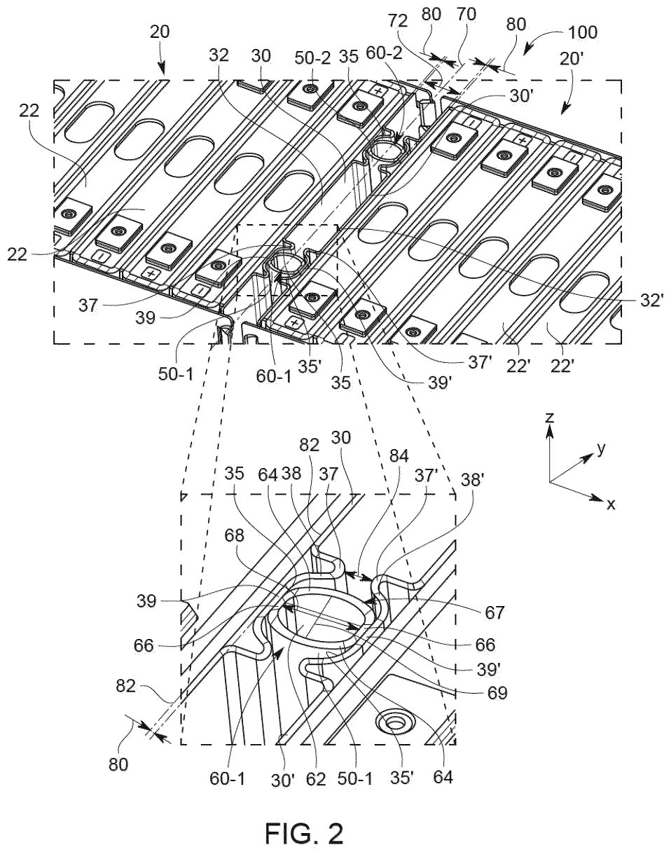

FIG. 1 is a schematic of a perspective view of a battery system 100 according to some embodiments. In one or more embodiments, FIG. 2 illustrates an enlarged view of II shown in FIG. 1. In the following, the description refers to both FIGS. 1 and 2 for providing a detailed illustration of the present disclosure.

Referring to FIGS. 1 and 2, a battery system 100 is provided and is described in more detail. The battery system 100 may include a first battery module 20 and a second battery module 20′ as shown in FIGS. 1 and 2.

Further, FIGS. 1 and 2 show that the first battery module 20 and the second battery module 20′ each includes a plurality of battery cells 22, 22′, respectively. In some embodiments, the battery cells 22, 22′ may be prismatic battery cells. The battery cells 22, 22′ may be stacked in a lengthwise direction (x-direction in FIG. 1) of the corresponding battery module 20, 20′. However, the disclosure is not limited thereto and more than one row of battery cells 22, 22′ may be provided. In one or more embodiments, more than two battery modules 20, 20′ in the lengthwise direction (x-direction in FIG. 1) may be provided. Further, battery cells 20, 20′ having different shapes may be utilized.

The first battery module 20 and the second battery module 20′ each include a plurality of frame portions 40, 40′. The frame portions 40, 40′ may define an insertion space (or an area) in which the plurality of battery cells 22, 22′ may be assembled or pre-assembled, as can be seen in FIG. 1. For example, the respective battery module 20, 20′ as described in FIG. 1 include two opposite long side frame portions 40, 40′ and two opposite short side frame portions, which will be described in more detail.

The first battery module 20 and the second battery module 20′ may be inserted in a housing 10. In some embodiments, only parts of the housing 10 are shown for illustration. The battery modules 20, 20′ may be press-fitted in the housing 10 as will be described later. FIG. 1 is an example of some embodiments and the present disclosure may include more than two battery modules 20, 20′ inserted into the housing 10 in a set or predefined manner, for example, more than two battery modules 20, 20′ in the lengthwise direction (x-direction in FIG. 1) and/or one more additional rows of battery modules.

A spanning mechanism may be provided between the battery modules 20, 20′. The first battery module 20 may include a first spanner plate 30, and the second battery module 20′ may include a second spanner plate 30′. In some embodiments, the corresponding spanner plates 30, 30′ may be formed on one from among a plurality of side portions of the battery modules 20, 20′. However, the embodiments of the present disclosure may also include other embodiments in which the spanner plate 30 is provided on more than one from among a plurality of side portions.

The first battery module 20 and the second battery module 20′ may be positioned relative to each other such that the first spanner plate 30 and the second spanner plate 30′ face each other. Thus, in other words, the first spanner plate 30 and the second spanner plate 30′ may form an interface 70 between each other, as indicated in FIG. 1. Because the interface 70 is formed between the first spanner plate 30 and the second spanner plate 30′ of the battery modules 20, 20′, a thermal transfer between the first battery module 20 and the second battery module 20′ may be reduced through the interface 70.

In some embodiments, the first spanner plate 30 and the second spanner plate 30′ are spaced from each other by a spanner plate gap 72 as indicated in FIGS. 1 and 2. In other word, the spanner plates 30, 30′ are spaced from each other at the interface 70. Thus, by providing the spanner plate gap 72, thermal transfer between the battery modules 20, 20′ is reduced which diminishes (or reduces) the risk of a thermal runaway spreading across the battery modules 20, 20′.

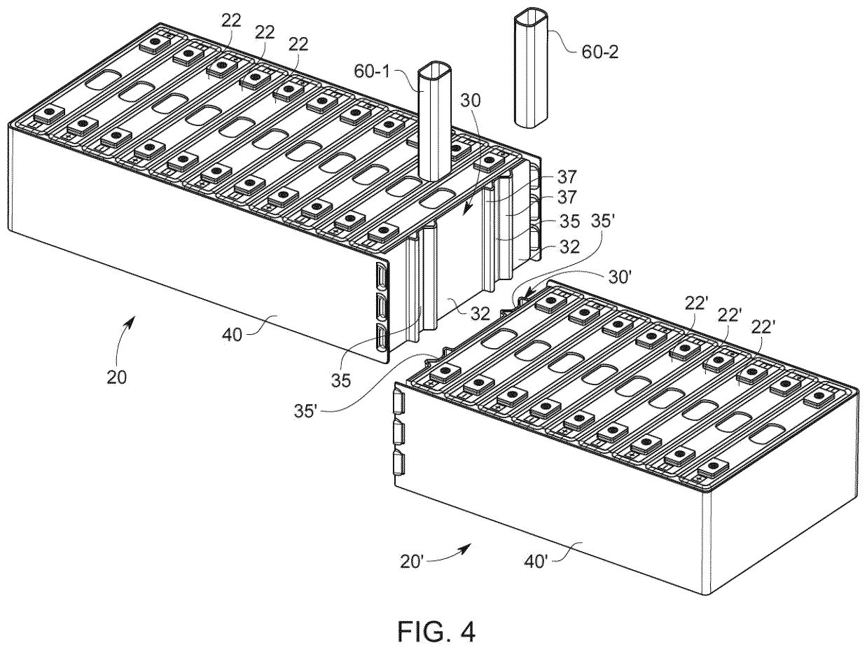

Referring to FIG. 2, the first spanner plate 30 and the second spanner plate 30′ respectively include at least one vertically extending depression 35, 35′, e.g., the depression 35, 35′ extending in a height direction of the battery modules (z-direction in FIG. 2). Thus, the first spanner plate 30 may include at least one vertically extending depression 35 and the second spanner plate 30′ may include at least one vertically extending depression 35′. In some embodiments, each of the first spanner plate 30 and the second spanner plate 30′ may include two vertically extending depressions as indicated in FIGS. 1 and 2. That is, the depressions 35, 35′ vertically extend (along the z-axis) with respect to the spanner plates 30, 30′, and are more clearly shown in FIG. 4.

Furthermore, the vertically extending depressions 35, 35′ of the two different battery modules 20, 20′ are facing each other. Therefore, the opposite depressions 35, 35′ may form a pair or pairs of depressions as indicated in FIGS. 1 and 2. Therefore, the vertically extending depressions 35, 35′ form at least one common accommodation space 50-1, 50-2. In more detail, in the case where two vertically extending depressions 35, 35′ are provided as indicated in FIGS. 1 and 2, two accommodation spaces 50-1, 50-2 may be formed. Further, in the case where one vertically extending depressions 35, 35′ is formed, one accommodation spaces 50-1, 50-2 is formed, e.g. at a center of the facing portions of the battery modules 20, 20′.

In some embodiments, because the depressions 35, 35′ extend vertically, at least one common accommodation space 50-1, 50-2 extends in the vertical direction, e.g., in the height direction (z-direction). The accommodation spaces 50-1, 50-2 may not be entirely closed in the widthwise direction (e.g., y-direction) of battery modules 20, 20′ as indicated in FIG. 2 but may be at least partially open, e.g., parallel to the interface 70. Thus, an accommodation gap 84 between the first spanner plate 30 and the second spanner plate 30′ may be provided, which increases the barrier of thermal transfer across the interface 70 to reduce the risk of spread of thermal runaway.

A rotation spanner member 60-1, 60-2 may be positioned in the at least one accommodation space 50-1, 50-2. In some embodiments, two rotation spanner members 60-1, 60-2 are provided respectively in the corresponding accommodation spaces 50-1, 50-2. However, in one or more embodiments, only one rotation spanner member 60-1 in one common accommodation space 50-1 may be provided.

The rotation spanner member 60-1, 60-2 may be formed to vertically extend in the respective accommodation space 50-1, 50-2, e.g., in the height direction. Thus, the rotation spanner member 60-1, 60-2 may be shaped to fit into the accommodation space 50-1, 50-2. Referring to FIG. 2, the cross section 62 of the rotation spanner member 60-1, 60-2 may be elongated in an elongation direction ED. The rotation spanner member 60-1, 60-2 may be hollow to reduce weight but the embodiments of the present disclosure are not limited thereto and the rotation spanner member 60-1, 60-2 may also be solid.

As can be seen in FIG. 2, the rotation spanner member 60-1, 60-2 may be oriented such that the elongation direction ED of the cross section 62 is normal (e.g., perpendicular) to the interface 70, e.g., points across the interface 70 (y-direction) in FIG. 2 of the present disclosure.

The rotation spanner member 60-1, 60-2 may be configured to press onto the spanner plates 30, 30′ to press on the first and second battery module 20, 20′ if (e.g., when) the elongation direction ED of the cross section 62 is oriented to be normal (e.g., perpendicular) to the interface 70 between the first and second battery module 20, 20′. Thus, because the rotation spanner member 60-1, 60-2 has an elongation 67 in the elongation direction ED, a pressing force may be provided (or applied). For the inserted battery modules 20, 20′ a press-fit of the first and second battery module 20, 20′ in the housing 10 is provided through the rotation spanner member 60-1, 60-2. For example, due to the elongation 67 having an elongation length 68 being larger than a width 69, the rotation spanner member 60-1, 60-2 can cause the first and the second battery module 20, 20′ to be displaced (e.g., moved or pushed away) from each other in response to rotating the rotation spanner member 60-1, 60-2 from a parallel orientation to the normal (e.g., perpendicular) orientation, the latter (e.g., the perpendicular orientation) being shown in FIG. 2. In this manner, a press-fit is generated in the housing 10. In other words, the displacement of the first and the second battery module 20, 20′ may cause the press-fit in the housing 10.

Further, the rotation spanner member 60-1, 60-2 may be configured to exert no pressing force onto the spanner plates 30, 30′ if (e.g., when) the elongation direction ED of the cross section 62 is parallel to the interface 70 between the first and second battery module 20, 20′. Thus, due to a rotation, a press-fit of the battery modules 30, 30′ in the housing 10 may be achieved. Thus, the battery modules 20, 20′ may be easily obtained by a rotation between parallel orientation to the interface 70 and a normal (e.g., perpendicular) orientation.

Therefore, the battery system 100 includes a spanner mechanism with spanner plates 30, 30′, which allows for stably press-fit battery modules 20, 20′ in the housing 10, including tolerance compensation from the action of the rotation spanner member in the housing 10, and while reducing heat transfer between the battery modules 20, 20′ to protect against thermal runaway. In one or more embodiments, the battery system 100 may be assembled and disassembled in a relatively easy manner by including a rotation step. Thus, the spacing, here through the spanning plates 30, 30′ is not a loss of space (e.g., wasted space) but rather works as spanning mechanism to provide the press-fit in the housing 10.

As can be seen in FIG. 2, the cross section 62 of the rotation spanner member 60-1, 60-2 may have curved portions 64 between two elongation end portions 66. The curved portions 64 may allow to easily rotate the rotation spanner member 60-1, 60-2 in the accommodating space so that the battery system 100 may be easily assembled and disassembled.

In one or more embodiments, the cross section 62 may be formed to be symmetrical with respect to the elongation direction ED, such that rotations in opposite directions may be performed in substantially the same manner.

Referring to FIG. 2 in more detail, the elongation end portions 66 are flat and extend normal (e.g., perpendicular) to the elongation direction ED. Due to the flat elongation end portions 66, the rotation spanner members 60-1, 60-2 cannot unintentionally rotate back from the pressing orientation normal (e.g., perpendicular) to the interface 70. Thus, a stability of the press-fit configuration is improved.

Regarding the shape of the depressions, at least one depression 35, 35′ may be formed between two protruding portions 37 of the first and second spanner plates 30, 30′. The depressions 35, 35′ may include a flat portion 39, 39′ between the protruding portions 37, 37′. The flat portion 39, 39′ of the depression 35, 35′ abuts the flat elongation end portion 66 of the rotation spanner member 60-1, 60-2. Thus, a substantially homogenous area contact can be reached to enhance the pressing contact.

Further referring to FIG. 2 (see the larger drawing), at least one depression 35, 35′ may be formed between flat plate portions 32 of the respective spanner plate 30, 30′. The flat plate portions 32 may form (or provide) the main part of the respective spanner plates 30, 30′ on which the depression 35, 35′ are formed. A depression gap 80 may be formed between at least one depression 35, 35′ and a plane 82 defined by the flat plate portions 32 of the respective spanner plate 30, 30′. Thus, as can be seen in FIG. 2, due to the depression gap 80 formed at the contact parts, thermal transfer in this region is reduced. Thus, although there is a mechanical contact, the contact zone is separated from the battery cells, so that heat transfer is reduced in a case the battery module 20, 20′ overheats.

Referring to FIGS. 1 and 2, the first spanner plate 30 and the second spanner plate 30′ are formed to respectively include two vertically extending depressions 35, 35′. The depressions 35, 35′ may be displaced (or spaced) from each other along the interface 70. Thus, two common accommodation spaces 50-1, 50-2 are provided, which are also displaced (or spaced) from each other along the interface 70. Thus, the first and the second rotation spanner members 60-1, 60-2 may be respectively positioned in a corresponding accommodation space 50-1, 50-2. As will be explained further, the two rotation spanner members 60-1, 60-2 may be be rotated mirror-inverted, which allows to avoid or reduce shear movement of the battery modules 20, 20′ during the assembly process. Thus, the two rotation spanner members 60-1, 60-2 according to the described embodiments may improve the press-fit and the positioning in the housing 10.

Referring again to FIG. 1, the first battery module 20 and the second battery module 20′ may include a plurality of frame portions 40, 40′. The respective spanner plate 30, 30′ may form at least one of the plurality of frame portions 40,40′. Thus, the spanner plate 30, 30′ form an end plate for both the first battery module 20 and the second battery module 20′. Thus, the respective spanner plate 30, 30′ may have the additional function of mechanically supporting the battery cells 22, 22′ in the respective battery module 20, 20′.

In one or more embodiments, the frame portions 40, 40′ include one or more slits 42, 42′ (e.g., three slits). The slits 42, 42′ may be embedded in a slit structure. A flap of the spanner plate 30, 30′ may be inserted into a corresponding slit 42, 42′ to stably couple the spanner plate 30, 30′ with the frame portion 40, 40′. Thus, a stable framing of the respective battery modules 20, 20′ may be provided despite having the spanner plates 30, 30′ on at least one side portion thereof. The slits 42, 42′ may be provided in a slit structure in which the slits 42, 42′ are embedded.

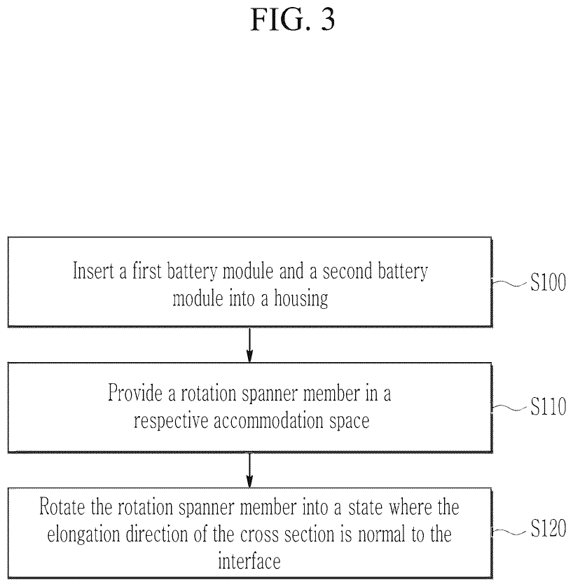

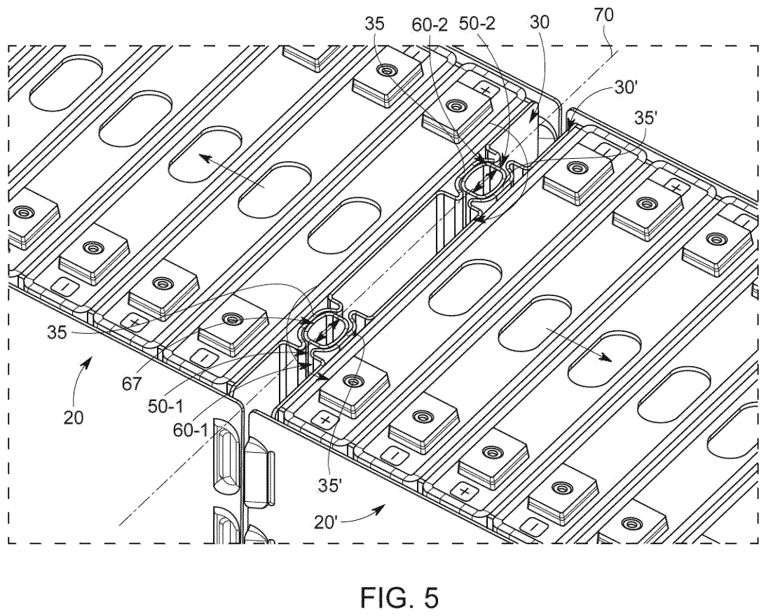

FIG. 3 is a method of assembling the battery system 100 according to one or more embodiments. The method is further illustrated by referring to FIGS. 4 and 5 to illustrate individual steps thereof.

The method of assembling may include inserting S100 a first battery module 20 and a second battery module 20′ into a housing 10. The battery modules 20, 20′ may be configured according to the detailed description provided with reference to FIGS. 1 and 2 described according to one or more embodiments.

The first battery module 20 and the second battery module 20′ may each include a plurality of battery cells 22, 22′ as seen in FIG. 4. Further, as explained above, the first battery module 20 may include a first spanner plate 30, and the second battery module 20′ may include a second spanner plate 30′ on at least one from among a plurality of side portions of the battery modules 20, 20′. As illustrated, for example, in FIG. 4, the first battery module 20 and the second battery module 20′ are arranged so that the first spanner plate 30 and the second spanner plate 30′ face each other. This arrangement can be provided either prior to inserting or can be done during the insertion process.

The first spanner plate 30 and the second spanner plate 30′ may be formed to respectively include at least one vertically extending depression 35, 35′ facing each other. Thus, opposite depressions 35, 35′ (e.g., depressions that are opposite from each other) form at least one common accommodation space 50-1, 50-2 as shown in FIG. 5. The mutual arrangement may be done prior to insertion or in the insertion process.

Further as illustrated in FIG. 4, the method may include providing S110 a rotation spanner member 60-1, 60-2 in a respective accommodation space 50-1, 50-2. The rotation spanner member 60-1, 60-2 may be inserted after the battery modules 20, 20′ are inserted in the housing 10. However, the rotation spanner member 60-1, 60-2 may also be provided in the accommodation space 50-1, 50-2 prior to performing the inserti step. As already explained in more detail above, a cross section 62 of the rotation spanner member 60-1, 60-2 may be elongated in an elongation direction ED. Accordingly, steps S110 and S120 may be performed simultaneously.

In some embodiments, the rotation spanner member 60-1, 60-2 may initially be provided in the accommodation space 50-1, 50-2, such that the elongation direction ED of the cross section 62 is parallel to the interface 70 between the first and second battery modules 20, 20′. In these embodiments little to no spanning force is exerted on the battery modules 20, 20′. In these embodiments, substantially the entire length of the battery modules 20, 20′ is reduced because the elongation direction ED (elongation width 67) is directed along the interface 70. This configuration is shown in FIG. 5. In these embodiments, the battery modules 20, 20′ may have tolerance with respect to the housing 10. Thus, in these embodiments, there may be, for example, a small space between the battery modules 20, 20′ (sides thereof) and the housing 10. Assembly tools may be provided to install and insert the components.

In one or more embodiments, as shown in FIG. 5, the method may include rotating S120 the at least one rotation spanner member 60-1, 60-2 into a state where the elongation direction ED of the cross section 62 is normal (e.g., perpendicular) to the interface 70. Then, the rotation spanner member 60-1, 60-2, e.g., the elongation 67 thereof, exerts an elastic pressing force onto the first and second battery module 20, 20′. Thus, by rotating the rotation spanner member 60-1, 60-2 as shown in FIG. 5, the battery modules 20, 20′ may be pushed apart (or separated) from each other in an outward direction (see, for example, arrows in FIG. 5). Thus, a press-fit of the first and second battery module 20, 20′ with the housing 10 may be provided. As illustrated in FIG. 5, compared to e.g., FIG. 2, a rotation of 90° achieves the maximum displacement or separation of the battery modules 20, 20′ resulting in a pressing force of the battery modules 20, 20′ in the housing 10. Rotating tools may be utilized to rotate the rotation spanner member 60-1, 60-2.

Thus, the rotation spanner member 60-1, 60-2 allows a press-fit to stably support the battery modules 20, 20′ in the housing 10, while reducing thermal transfer due to the interface 70. Therefore, machining may not be required in the assembly methods according to the embodiments of the disclosure, thus reducing assembly costs.

Referring to FIG. 5, the first spanner plate 30 and the second spanner plate 30′ may be formed to respectively include two vertically extending depressions 35, 35′ arranged to form two common accommodation spaces 50-1, 50-2 separated from each other along the interface 70. Thus, a first and a second rotation spanner members 60-1, 60-2 may be respectively positioned in the corresponding accommodation spaces 50-1, 50-2. Accordingly, the rotating step may include rotating the first and second rotation spanner members 60-1, 60-2 in opposite directions from each other. Thus, shear movement of the battery modules 20, 20′ may be avoided in the assembly process.

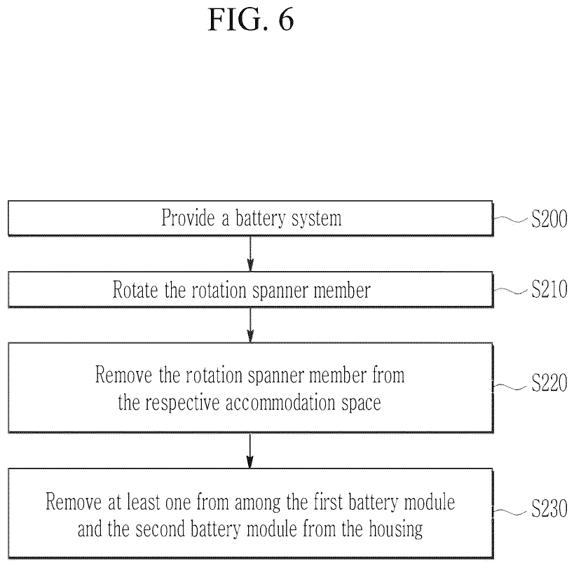

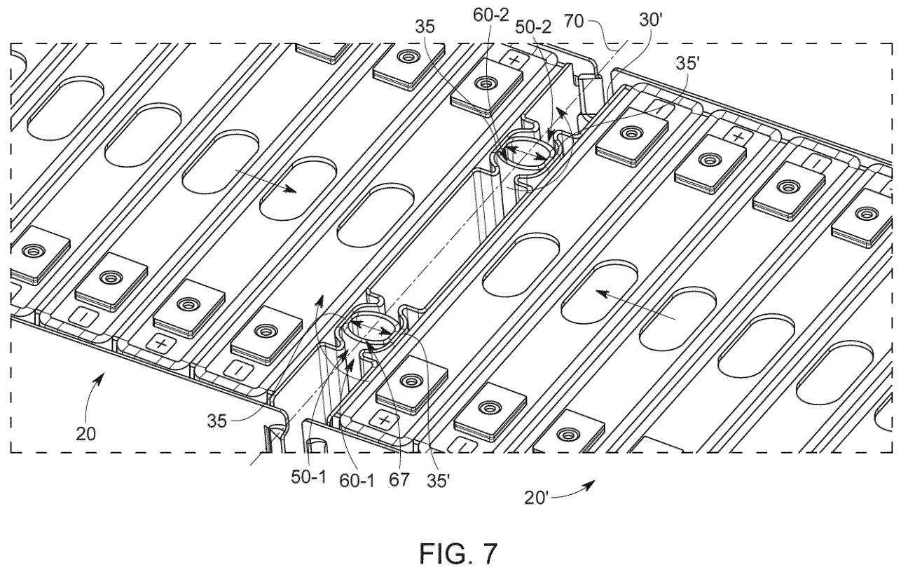

Referring now to FIG. 6, a method of disassembling the battery system 100 is illustrated according to one or more embodiments. The method is further explained with reference to FIG. 7.

The method for disassembling a battery system 100 may be initiated by providing S200 a battery system 100 as disclosed in the embodiments as disclosed with respect to FIGS. 1 and 2. Thus, at least one rotation spanner member 60-1, 60-2 may be oriented (or rotated) so that the elongation direction ED of the cross section rotated from the parallel orientation to the normal (e.g., perpendicular) to the interface 70 as indicated in FIG. 7, which shows the press-fitted configuration.

In some embodiments, the disassembling method may further include rotating S210 the at least one rotation spanner member 60-1, 60-2 so that the elongation direction ED of an elongation 67 becomes parallel to the interface 70. Thus, the press-fit caused by the elongation of the cross section may be resolved by the rotation process.

The disassembling method may further include removing S220 the rotation spanner members 60-1, 60-2 from the respective accommodation spaces 50-1, 50-2.

In some embodiments, the method may further include removing S230 at least one from among the first battery module 20 and the second battery module 20′ from the housing 10. Therefore, the defective battery module 20, 20′ or a defective battery cell 22, 22′ may be easily replaced by reversing the assembly steps as described with respect to FIG. 3.

Further, in the case where the first spanner plate 30 and the second spanner plate 30′ are formed to respectively include two vertically extending depressions 35, 35′ arranged to form two common accommodation spaces 50-1, 50-2 displaced (or spaced) from each other along the interface 70, a first and a second rotation spanner members 60-1, 60-2 may be respectively positioned in a corresponding accommodation space 50-1, 50-2. Then, the rotating step may include rotating the first and second rotation spanner member 60-1, 60-2 in opposite direction from each other. Accordingly, this may prevent or reduce shear movement of the battery modules 20, 20′ during the disassembling process. Thus, reusability of the battery system 100 may improved and the battery system 100 may still be operated even if (or when) one battery module is removed. Thus, the maintaining of the battery system 100 is improved.

In summary, a battery system 100 is provided including a spanner mechanism with spanner plates 30, 30′, which allow for stably press-fit battery modules 20, 20′ in a housing 10, while concurrently (e.g., simultaneously) reducing heat transfer between the battery modules 20, 20′ to protect against thermal runaway. In one or more embodiments, the battery system 100 may be assembled and/or disassembled in a relatively easy manner involving a rotation step, thereby reducing impact on the battery modules 20, 20′, which reduces manufacturing costs. Thus, the spacing from the spanning plates 30, 30′ does not result in a loss of space (or wasted space) but rather works as spanning mechanism to provide the press-fit in the housing 10. Further, battery cells 22, 22′ may be easily replaced while the rest of the battery system 100 remains usable.

### REFERENCE SIGNS

100 battery system
10 housing
20 first battery module
22 battery cells
30 first spanner plate
32 flat plate portion
35 depression
37 protruding portion
38 curved portion
39 flat portion
40 frame portion
42 slit (structure)
20′ second battery module
22′ battery cells
30′ second spanner plate
32′ flat plate portion
35′ depression
37′ protruding portion
38′ curved portion
39′ flat portion
40′ frame portion
42′ slit (structure)
50-1, 50-2 accommodation space (first/second)
60-2, 60-2 rotation spanner member (first/second)
62 cross section
64 curved portion
66 elongation end portion
67 elongation
68 elongation length
69 width
70 interface
72 spanner plate gap
80 depression gap
82 plane
84 accommodation gap

What is claimed is:

1. A battery system, comprising:
a first battery module and a second battery module in a housing, wherein the first battery module and the second battery module each comprise a plurality of battery cells, the first battery module comprising a first spanner plate the second battery module comprises a second spanner plate on at least one among a plurality of side portions of the battery modules, wherein the first spanner plate and the second spanner plate define an interface therebetween;
the first spanner plate and the second spanner plate each comprise at least one depression facing each other to form at least one common accommodation space;
the at least one common accommodation space comprises a rotation spanner member extending vertically in the respective common accommodation space, wherein a cross section of the rotation spanner member comprises an elongation in an elongation direction; and
the rotation spanner member is oriented such that the elongation direction of the cross section is perpendicular to the interface.

2. The battery system as claimed in claim 1, wherein the cross section comprises curved portions between two elongation end portions.

3. The battery system as claimed in claim 2, wherein the rotation spanner member is configured to exert an elastic pressing force to the first and second battery module to press-fit the first and second battery module in the housing.

4. The battery system as claimed in claim 2, wherein the elongation end portions are flat and extend perpendicular to the elongation direction.

5. The battery system as claimed in claim 4, wherein the at least one depression is between two protruding portions of the respective spanner plate, wherein the at least one depression comprises a flat portion between the two protruding portions.

6. The battery system as claimed in claim 5, wherein the flat portion of the at least one depression abuts the flat elongation end portion of the rotation spanner member.

7. The battery system as claimed in claim 1, wherein the at least one depression is between flat plate portions of the respective spanner plate, wherein a depression gap is defined between the at least one depression and a plane defined by the flat plate portions of the respective spanner plate.

8. The battery system as claimed in claim 1, wherein the first battery module and the second battery module comprise a plurality of frame portions, wherein the respective spanner plate forms at least one of the plurality of frame portions.

9. The battery system as claimed in claim 8, wherein at least one of the plurality of frame portions comprise a slit configured to couple a flap of the respective spanner plate to the frame portion.

10. The battery system as claimed in claim 1, wherein the first spanner plate and the second spanner plate respectively comprise two vertically extending depressions, the two vertically extending depressions defining two common accommodation spaces spaced from each other along the interface; and
a first and a second rotation spanner members respectively in a corresponding common accommodation space.

11. A method for assembling a battery system, comprising:
inserting a first battery module and a second battery module in a housing, wherein the first battery module and the second battery module each comprise a plurality of battery cells,
wherein the first battery module comprises a first spanner plate and the second battery module comprises a second spanner plate on at least one among a plurality of side portions of the battery modules, wherein the first battery module and the second battery module are arranged such that the first spanner plate and the second spanner plate define an interface therebetween, and
wherein the first spanner plate and the second spanner plate are formed to respectively comprise at least one vertically extending depression facing each other to form at least one common accommodation space;
providing a rotation spanner member in the respective common accommodation space, wherein a cross section of the rotation spanner member comprises an elongation in an elongation direction, such that the elongation direction of the cross section is parallel to the interface between the first and second battery module; and
rotating at least one rotation spanner member into a state where the elongation direction of the cross section is perpendicular to the interface to exert an elastic pressing force onto the first and second battery module to press-fit the first and second battery module in the housing.

12. The method as claimed in claim 11,
wherein the first spanner plate and the second spanner plate each respectively comprise two vertically extending depressions, wherein the two vertically extending depression form two common accommodation spaces spaced from each other along the interface; and
wherein a first and a second rotation spanner members are respectively in a corresponding common accommodation space, wherein the rotating the at least one rotation spanner member comprises rotating the first and second rotation spanner members in opposite directions.

13. A method for disassembling a battery system as claimed in claim 1, the method comprising:
rotating at least one of a first or a second rotation spanner member such that the elongation direction is parallel to the interface;
removing the at least one of the first or the second rotation spanner members from the respective common accommodation space; and
removing at least one among the first battery module and the second battery module from the housing.

14. The method as claimed in claim 13, wherein the rotating comprises rotating the first and second rotation spanner members in opposite directions.

15. A vehicle comprising the battery system as claimed in claim 1.
